(19) United States
(12) Patent Application Publication
(10) Pub. No.: US 2024/0043334 A1
(43) Pub. Date: Feb. 8, 2024

(54) FIRE RETARDANT INTUMESCENT COATING COMPOSITIONS, WOOD COMPOSITE PRODUCTS AND METHODS OF MAKING AND USING THE SAME

(71) Applicant: Arclin USA LLC, Roswell, GA (US)

(72) Inventors: Arun Narayan, Duluth, GA (US); Samuel Walter Lonberg, Fuquay Varina, NC (US); Morgan Higgins, Holly Springs, NC (US); Guillermo Jose Velarde, Cary, NC (US)

(73) Assignee: Arclin USA LLC, Roswell, GA (US)

(21) Appl. No.: 18/364,271

(22) Filed: Aug. 2, 2023

Related U.S. Application Data
(60) Provisional application No. 63/370,175, filed on Aug. 2, 2022.
(60) Provisional application No. 63/370,161, filed on Aug. 2, 2022.
(60) Provisional application No. 63/370,181, filed on Aug. 2, 2022.

(51) Int. Cl. C04B 28/26; C04B 18/14; C04B 14/04; C04B 14/18; C04B 14/02; C04B 14/30; C04B 24/26; C04B 24/00; C04B 24/02

(52) U.S. Cl. CPC C04B 28/26; C04B 18/146; C04B 14/041; C04B 14/18; C04B 14/024; C04B 14/303; C04B 24/2688; C04B 24/003; C04B 24/02; C04B 2111/00508

(57) ABSTRACT

Geopolymer-based fire retardant intumescent coating compositions, methods of making and using the same are provided. Wood composite products prepared from geopolymer-based fire retardant intumescent coating compositions are also provided.

### CROSS REFERENCE TO RELATED APPLICATIONS

This application claims priority to and benefit of U.S. Provisional Application Nos. 63/370,161, filed on Aug. 2, 2022, 63/370,175, filed on Aug. 2, 2022, and 63/370,181, filed on Aug. 2, 2022, all of which are incorporated by reference in their entirety.

### FIELD OF THE INVENTION

Embodiments described herein generally relate to fire retardant intumescent coating compositions. More particularly, such embodiments relate to geopolymer-based fire retardant intumescent coating compositions, methods of making and using the same, and the wood composite products.

### BACKGROUND OF THE INVENTION

Fire retardant (FR) coatings have been developed to control fire by various means, including raising the combustion temperature, reducing the rate of burning, reducing flame propagation and reducing smoke generation. Fire-retardant coatings, adhesives are used in various fields and are of particular importance in the construction, automotive and aircraft applications/industries.

In the construction industry, interior components, like floors, interior walls, partitions, ceiling and exterior components such as sidings etc., must withstand fire and emit minimum quantities of smoke and other toxic fumes during combustion. Fire-retardant compositions are well known for decreasing the flammability or combustibility of materials, in particular wood and wood products, and for increasing the resistance of these materials to heat and flame damage. Wood and wood products have numerous desirable qualities as construction materials, including relatively low cost, structural strength, paint-ability and stain-ability, insulating properties, wide availability, renewability of the resource, and pleasing aesthetic characteristics. As a result, wood and wood products are used extensively as building materials for residential and commercial applications by the construction industry. Flammability, however, is the most notable disadvantage of using wood and wood products as construction materials. The susceptibility of wood to fire-related damage leads to millions of dollars per year in property damage, and also produces significant human injury and loss of life.

A number of building codes, for example, the International Residential Code (IRC), the Life Safety Code (NFPA 101), and the Building Construction and Safety Code (NFPA 5000), recognize that wood impregnated with fire retardant compositions that meet certain performance criteria may be used in place of noncombustible materials for exterior walls of Type I, II, III and buildings and in roof structures of type II and low-rise buildings of Type I construction (NFPA 5000). Most of these building codes require fire-retardant treated wood (FTRW) to perform to certain levels in accordance with tests set out in ASTM E-84 (“Standard Test Method of Surface Burning Characteristics of Building Materials”), NFPA 255 (“Standard Method of Test of Surface Burning Characteristics of Building Materials”) or UL 723 (“Standard for Test for Surface Burning Characteristics of Building Materials. Although the standard flame-spread test in ASTM E-84, for example, is based on a 10-minute exposure in a fire test tunnel furnace, under controlled conditions of draft and temperature, as specified in ASTM E-84, the test period for FRTW is extended to 30 minutes to confirm that the wood does not demonstrate significant progressive combustion. According to these tests, wood designated FTRW must demonstrate surface burning characteristics in a 30-minute extended burn test that the “flame spread index shall be 25 or less and there shall be no evidence of significant progressive combustion when the test is continued for an additional 20-minute period. Additionally, the flame front shall not progress more than 10½ feet (3200 mm) beyond the centerline of the burners at any time during the test. The smoke-developed index shall be 450 or less.”

Commercial fire-retardant formulations for pressure impregnating wood products contain: (1) various phosphate compounds, including mono-ammonium phosphate (MAP), diammonium phosphate (DAP), ammonium polyphosphate and metal salts of phosphoric acid; (2) sulfate compounds, such as ammonium sulfate, copper sulfate, and zinc sulfate; (3) halogenated compounds, such as zinc chloride and ammonium bromide; (4) nitrogen compounds, such as dicyandiamide and urea; or (5) boron compounds, such as boric acid, sodium borates or other metal borates.

The industry uses coatings for treating wood products to provide them with a fire rating Commercial formulations for coating wood products for the purposes of fire ratings are well known in the art. Generally, such coatings comprise one or more polymer binders, a mineral acid catalyst, a carbon source, and a source of non-flammable gas. The industry uses either fire-retardant impregnated wood to confer fire retardant property to wood, or uses coatings to provide a fire rating. In addition to the disadvantages discussed above with those methods, certain wood products do not pass the ASTM E-84 30-minute burn test.

Despite many efforts to address these deficiencies in fire-retardant formulations, there remains an unmet need to develop a fire-retardant technology for wood products with sufficient fire-retardant properties to pass industry and code-specified tests for fire retardant property and suitable for commercial use. For example, the optimal fire retardant should be less hygroscopic and less corrosive to metal fasteners, has long-term thermal stability, and imparts excellent fire-retardant characteristics to wood based products.

Therefore, it is an object of the invention to provide geopolymer-based fire retardant intumescent coating compositions, and methods of making and using the same.

It is another object of the invention to provide fire retardant intumescent coating compositions prepared from unique geopolymer formulation (that includes filler(s) of choice) by itself and in combination with an aerogel (heat sink) and an organic intumescent coating component along with a substrate that exhibit unique and drastically improved finished product properties with zero emissions and significantly improved FR characteristics.

It is still another object of the invention to provide fire retardant intumescent coating composition with improved mechanical properties.

It is also object of the invention to provide geopolymer-based fire retardant wood-based composite construct and panels, saturation and/or coating of paper and other carriers for use as an overlay in the lamination process.

It is further object of the invention to provide new geopolymers, lignosulfonate and/or polyol stabilizer binder systems that can be used as the novel no emissions/no-added formaldehyde resin system that performs better than incumbent technology and can potentially be a good moisture barrier.

### SUMMARY OF THE INVENTION

Geopolymer-based fire retardant intumescent coating compositions, methods of making and using the same are provided. Wood composite products prepared from geopolymer compositions are also provided.

In some embodiments, a fire retardant intumescent coating composition, can include an alkali metal geopolymer binder; and at least one filler.

In other embodiments, a method for preparing a fire retardant intumescent coating composition, can include placing a substrate on a coating stage; pouring a geopolymer mix at the top of the substrate; spreading the geopolymer mix evenly with groove rod or paint roller; curing the coated substrate in an oven at 80° C. for about 5 minutes; repeating the coating process on the opposite side of the substrate; curing the coated substrate in an oven at 80° C. for about 15 minutes; and placing the double-coated substrate samples in an individual plastic bags prior to flame testing to form the fire retardant intumescent coating composition.

In some embodiments, a method for preparing a wood composite product, can include contacting a plurality of wood substrates with a fire retardant intumescent coating composition, wherein the coating composition can include an alkali metal geopolymer binder; and at least one filler; and curing the coating composition to produce the wood composite product.

In another embodiment, a wood composite product, can include a plurality of wood substrates and at least cured fire retardant intumescent coating composition, wherein the coating composition can include an alkali metal geopolymer binder; and at least one filler.

In some embodiments, a fire retardant intumescent coating composition, can include an alkali metal geopolymer binder; at least one filler; and a gel.

In other embodiments, a method for preparing a wood composite product, can include contacting a plurality of wood substrates with a fire retardant intumescent coating composition, wherein the coating composition can include an alkali metal geopolymer binder; at least one filler; and a gel; and curing the coating composition to produce the wood composite product.

In another embodiment, a wood composite product, can include a plurality of wood substrates and at least cured fire retardant intumescent coating composition, wherein the coating composition can include an alkali metal geopolymer binder; at least one filler; and a gel.

In some embodiments, a fire retardant intumescent coating composition, can include an alkali metal geopolymer binder; at least one filler; and an organic intumescent coating component.

In other embodiments, a method for preparing a wood composite product, can include contacting a plurality of wood substrates with a fire retardant intumescent coating composition, wherein the coating composition can include an alkali metal geopolymer binder; at least one filler; and an organic intumescent coating component; and curing the coating composition to produce the wood composite product.

In another embodiment, a wood composite product, can include a plurality of wood substrates and at least cured fire retardant intumescent coating composition, wherein the coating composition can include an alkali metal geopolymer binder; at least one filler; and an organic intumescent coating component.

In some embodiments, a fire retardant intumescent coating composition, can include an alkali metal geopolymer binder; at least one filler; a gel; and an organic intumescent coating component.

In other embodiments, a method for preparing a wood composite product, can include contacting a plurality of wood substrates with a fire retardant intumescent coating composition, wherein the coating composition can include an alkali metal geopolymer binder; at least one filler; a gel; and an organic intumescent coating component; and curing the coating composition to produce the wood composite product.

In another embodiment, a wood composite product, can include a plurality of wood substrates and at least cured fire retardant intumescent coating composition, wherein the coating composition can include an alkali metal geopolymer binder; at least one filler; a gel; and an organic intumescent coating component.

In some embodiments, a fire retardant intumescent coating composition, can include an alkali metal geopolymer binder; at least one filler; a gel; an organic intumescent coating component; and a paper overlay saturated with geopolymer composition.

In other embodiments, a method for preparing a wood composite product, can include contacting a plurality of wood substrates with a fire retardant intumescent coating composition, wherein the coating composition can include an alkali metal geopolymer binder; at least one filler; a gel; an organic intumescent coating component; and a paper overlay saturated with geopolymer composition; and curing the coating composition to produce the wood composite product.

In another embodiment, a wood composite product, can include a plurality of wood substrates and at least cured fire retardant intumescent coating composition, wherein the coating composition can include an alkali metal geopolymer binder; at least one filler; a gel; an organic intumescent coating component; and a paper overlay saturated with geopolymer composition.

In further embodiment, a paper overlaid wood board, can include an oriented strand board core having a bottom surface and a top surface, wherein the oriented strand board comprises a plurality of strands; and at least cured fire retardant intumescent coating composition, wherein the coating composition can include an alkali metal geopolymer binder; at least one filler; a gel; an organic intumescent coating component; a paper overlay saturated with geopolymer composition; and a coating composition adhesively secured to the top surface of the oriented strand board.

In some embodiments, a fire retardant intumescent coating composition, can include an alkali metal geopolymer binder; at least one filler; a gel; an organic intumescent coating component; and an aldehyde-based resin.

In other embodiments, a method for preparing a wood composite product, can include contacting a plurality of wood substrates with a fire retardant intumescent coating composition, wherein the coating composition can include an alkali metal geopolymer binder; at least one filler; a gel; an organic intumescent coating component; and an aldehyde-based resin and curing the coating composition to produce the wood composite product.

In another embodiment, a wood composite product, can include a plurality of wood substrates and at least cured fire retardant intumescent coating composition, wherein the coating composition can include an alkali metal geopolymer binder; at least one filler; a gel; an organic intumescent coating component; and an aldehyde-based resin.

### BRIEF DESCRIPTION OF THE DRAWINGS

FIG. 1 depicts an illustrative view of a fire retardant intumescent coating composition and wood panel of an alkali metal geopolymer binder and filler.

FIG. 2 depicts an illustrative view of a fire retardant intumescent coating composition and wood panel of an alkali metal geopolymer binder, filler, gel and an optional paper overlay.

FIG. 3 depicts an illustrative view of a fire retardant intumescent coating composition and wood panel of an alkali metal geopolymer binder, filler, organic intumescent coating component and an optional paper overlay.

FIG. 4 depicts an illustrative view of a fire retardant intumescent coating composition and wood panel of an alkali metal geopolymer binder, filler, gel, organic intumescent coating component and an optional paper overlay. FIG. 4 depicts an illustrative view of a fire retardant intumescent coating composition and wood panel of an alkali metal geopolymer binder, filler, gel, organic intumescent coating component and paper overlay saturated with geopolymer composition.

FIG. 5 depicts an illustrative view of a fire retardant intumescent coating composition and wood panel of an alkali metal geopolymer binder, filler, gel, organic intumescent coating component, aldehyde-based resin and an optional paper overlay.

FIG. 6 shows schematic view of RF or PRF gel batch process.

### DETAILED DESCRIPTION OF THE INVENTION

### I. Definitions

The following terms are intended to have the meanings presented therewith below and are useful in understanding the description and intended scope of the present invention.

The articles “a” and “an” may be used herein to refer to one or to more than one (i.e., at least one) of the grammatical objects of the article. By way of example “an analogue” means one analogue or more than one analogue.

The term “about” as used herein, refers that the numerical value is approximate and small variations would not significantly affect the practice of the disclosed embodiments. Where a numerical limitation is used, unless indicated otherwise by the context, “about” means the numerical value can vary by ±10% and remain within the scope of the disclosed embodiments. Additionally, in phrase “about X to Y,” is the same as “about X to about Y,” that is the term “about” modifies both “X” and “Y.”

The term “compound” as used herein, refers to salts, complexes, isomers, stereoisomers, diastereoisomers, tautomers, and isotopes of the compound or any combination thereof.

The term “comprising” (and any form of comprising, such as “comprise”, “comprises”, and “comprised”), “having” (and any form of having, such as “have” and “has”), “including” (and any form of including, such as “includes” and “include”), or “containing” (and any form of containing, such as “contains” and “contain”), are used in their inclusive, open-ended, and non-limiting sense.

The term “effective,” as that term is used in the specification and/or claims, means adequate to accomplish a desired, expected, or intended result.

### II. Fire Retardant Intumescent Coating Composition and Wood Composite Product from Alkali Metal Geopolymer Binder and Filler(s)

The term “coating” refers to a coating in a form that is suitable for application to a substrate as well as the material after it is applied to the substrate, while it is being applied to the substrate, and both before and after any post-application treatments (such as evaporation, cross-linking, curing, and the like). The components of the coating compositions may vary during these stages.

The coatings comprise an alkali metal geopolymer binder composition and may optionally comprise additional components, such as at least one carrier like filler, pigment, catalyst, or accelerator other than a binder. Coatings can be prepared using potassium geopolymer binder compositions of metakaolin, potassium silicate solution and fumed silica (SiO₂) filler and coating on a suitable substrate of choice.

Some non-limiting examples of types of binders include, but not limited to, polymeric binders. Polymeric binders (resins) can be thermoplastics or thermosets or modified natural alkyl resins and may be elastomers or fluoropolymers. Binders may also comprise monomers that can be polymerized before, during, or after the application of the coating to the substrate. Polymeric binders may be cross-linked or otherwise cured after the coating has been applied to the substrate. Examples of polymeric binders include polyethers such as poly(ethylene oxide)s (also known as poly(ethylene glycol)s, poly(propylene oxide)s (also known as poly(propylene glycol)s, and ethylene oxide/propylene oxide copolymers, cellulosic resins (such as ethyl cellulose, ethyl hydroxyethyl cellulose, carboxymethyl cellulose, cellulose acetate, cellulose acetate propionates, and cellulose acetate butyrates), and polyvinyl butyral, polyvinyl alcohol and its derivatives, ethylene/vinyl acetate polymers, acrylic polymers and copolymers, styrene/acrylic copolymers, styrene/maleic anhydride copolymers, isobutylene/maleic anhydride copolymers, vinyl acetate/ethylene copolymers, ethylene/acrylic acid copolymers, polyolefins, polystyrenes, olefin and styrene copolymers, urethane resins, isocyante resins. epoxy resins, acrylic latex polymers, polyester acrylate oligomers and polymers, polyester diol diacrylate polymers, UV-curable resins, and polyamide, including polyamide polymers and copolymers.

The coating industry is a material-intensive manufacturing industry. Materials which might be harmful to both humans and the environment are used in the manufacturing of most organic coatings. Harmful and hazardous materials used in the production process or in and after the preparation of the organic coating might volatilize into the atmosphere. The adverse impact on the environment resulting from the aforementioned materials has attracted global attention. In addition, the manufacture of organic coatings also consumes large quantities of natural resources, especially petroleum resources. The study of inorganic coatings has therefore been focused on. Inorganic coatings have many advantages. They are environmentally friendly, functional and have both technical and economic advantages. For example, sodium, potassium as well as lithium silicate resin cements, silica sols, phosphates and polysiloxanes are inorganic coating components.

The concept of geopolymers was brought up by Joseph Davidovits in the 1970s. The gist of this concept is an aluminum silicate inorganic polymer formed by geochemistry. The geopolymer has a network-like structure of amorphous inorganic polymer which has excellent adhesive properties, and especially shows a high bond strength in an early stage. Geopolymers also have the properties of good acid resistance, alkali resistance, seawater and high temperature resistance. Due to their impermeability, high degree of compactness, antifreeze properties, and especially excellent interface coalescence, geopolymers can be combined with different base materials to form a solid surface which can maintain long-term volume stability.

A wide range of products can be created by using geopolymers. Coatings are one of them. Coatings are decorative, protective and functional products. The majority thereof should have a desirable color. Therefore, white metakaolin as an aluminum silicate polymer can be provided for a white coating matrix, which also helps preparing bright colors. The color of the coating prepared from the geopolymer binder compositions according to the invention can be adjusted by incorporating one or more colorants such as organic or inorganic pigments or dyes into the geopolymer binder compositions. The type and amounts of the colorants can be chosen by a skilled person according to the requirements and are not restricted as long as the advantages of the invention are not impaired. As will be explained below, the coatings of the present invention can be used for various purposes. In order to modify the properties of the coating according to the needs, the geopolymer binder compositions can contain one or more optional components. The type and amount of the optional components will depend on the ultimate use of the geopolymer composition and are not particularly restricted. Examples of typical optional components are toughening agents, dispersing agents, plasticizers, levelling agents, and thickening agents. Furthermore, one or more functional agents which modify the properties of the geopolymer coating according to the intended use can be additionally contained in the geopolymer binder compositions.

Examples of such functional agents include, but not limited to, fire flame retardant agents (e.g., expanded graphite, melamine, hydrated glass powder, pentaerythritol, aluminum hydroxide); antimony trioxide, spherical closed cell expanded perlite, expanded vermiculite, fly ash particles, hollow glass beads, ceramic fiber powder, rockwool fiber powder); anti-rust agents (e.g., micaceous iron oxide, zinc metal, zinc powder, zinc oxide, glass flakes); antimicrobial agents (e.g., Ag₃PO₄—Zn₃(PO₋₁)₂, (Ag—Zn) antimicrobial powder); stealth agent (e.g., high temperature ceramic metal oxide powder (cobalt, manganese, nickel, iron, barium, and zinc), iron carbonyl); conductive agents (e.g., iron carbonyl powder, silver-copper, silver-nickel, silver glass powder, silver mica powder); heat agent (e.g., aluminum powder, stainless steel powder); lubricants (e.g., graphite phosphate tablets, (MoS₂)); metal protective agent (e.g., alkali glass powder, silicon carbide powder); antifouling agents (e.g., cuprous oxide, capsaicin); temperature indication agent (e.g., Cu₂(HgI₄), C0C₁₂ six-tetramine); and anti-radiation agent (e.g., PbO, BaSO₄, Fe₂O₃). Both the types and the amounts of the functional agent can be selected by a skilled person based on his general knowledge of the field.

The composition according to the present invention can be used to prepare a wide variety of coatings. Examples of possible coatings include, but not limited to, anti-crack architectural coatings, waterproof architectural coatings, zinc-rich coatings, anti-crack insulation coatings, waterproof insulation coatings, fire resistant coatings, anti-rust coatings, anti-mildew coatings, stealth coatings which are invisible to radar waves, conductive coatings, heat-proof coatings, lubricating coatings, antioxidant and anti-oxidation coatings, anti-pollution coatings, temperature indication coatings, anti-radiation coatings, and waterproof coatings. The coatings can be suitable for indoor and/or outdoor applications. If desired the coatings can be flexible.

In some embodiments, the deposition of an alkali metal geopolymer binder compositions onto the substrate is carried out by drop-cast, spray-cast, spin coating, dip coating, flow coating, knife coating, curtain coating, slot coating, brushing, dipping, spreading, spraying, wiping, or combinations thereof.

The geopolymer compositions of the present invention are advantageous because they do not rely on petrochemical products. Therefore, they do not require any volatile organic solvents or emit any volatile organic compounds. Rather, they can be formulated only using water as a solvent. In addition, they do not have aging problems, are incombustible, anti-corrosive, possess high strength, and are environmental friendly. Furthermore, the geopolymer-containing filler particles have a good flowability.

A composite material is a material of two or more components with different properties, which together give the final product properties that none of its components have in themselves. Composite materials, or composite products for short, consist of a matrix, also called a binder, and a reinforcement, called a filler. Reinforcement is a discontinuous component of the composite that is harder, stiffer and significantly stronger than the matrix. The matrix is a continuous component of the composite that connects the reinforcement. The matrix protects the reinforcement from external influences and prevents its damage.

Geopolymer materials or geopolymers are among the ceramic materials. It belongs to the aluminosilicates. Their advantage over traditional ceramic materials is their preparation at room temperature and very low shrinkage during maturation. Geopolymers excel in their resistance to temperatures higher than 1100° C. and chemical resistance. Geopolymers usually consist of a geopolymeric binder forming a matrix and a filler that has a reinforcing function. Geopolymeric binders are covalently bonded mineral polymers. Fillers in conjunction with a geopolymic binder generally give the resulting composite stiffness and strength, particularly if the chosen filler is reactive in nature and can participate in the geopolymerization reaction. However, a wide range of other materials can be incorporated into the structure of geopolymers, which then play a very significant role not only in their resulting mechanical properties, but also in their thermodynamic properties.

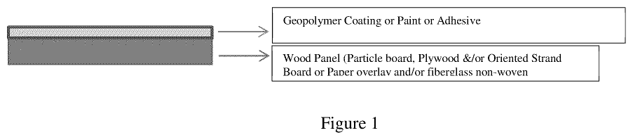

FIG. 1 depicts an illustrative view of a fire retardant intumescent coating composition and wood panel of an alkali metal geopolymer binder and filler.

In some embodiments, a fire retardant intumescent coating composition, can include an alkali metal geopolymer binder; and at least one filler.

In one embodiment, the alkali metal geopolymer binder can include a metakaolin; and an alkali silicate in a solvent.

In another embodiment, the coating composition further can include a paper overlay.

In other embodiments, the alkali metal is selected from the group consisting of lithium, sodium, potassium, rubidium, cesium, and mixtures thereof.

In another embodiment, the alkali silicate is selected from the group consisting of potassium silicate, sodium silicate, and mixtures thereof.

In some embodiments, the solvent can include an alkanol, an aromatic alcohol, and water. In one embodiment, the solvent is water.

In other embodiments, the filler is selected from the group consisting of multi-purpose sand, titanium dioxide, calcium carbonate, silicon dioxide, lignosulfonate, powdered graphite, cristoballite, feldspar, wollostonite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), cristoballite, feldspar, wollostonite, perlite, other aluminosilicate derivates, melamine, bisphenol A, sodium sulfate, sodium bicarbonate, hexamine, soda ash, sodium meta bisulfite, ammonium sulfate, elvamide, ethylene glycol, guar gum, stannous chloride, glycerin, paraformaldehyde, wheat/gluten flour, lithium carbonate, ammonium acetate, molasses, polyvinyl butural, polyvinyl alcohol, polyvinyl acetate, caprolactam, carboxy methyl cellulose (CMC), and mixtures thereof.

In some embodiments, the metakaolin is present in an amount from about 5 wt % to about 50 wt % based on the total composition, preferably, the metakaolin is present in an amount from about 5 wt % to about 35 wt % based on the total composition and more preferably, the metakaolin is present in an amount from about 5 wt % to about 10 wt % based on the total composition.

In other embodiments, the alkali silicate is present in an amount from about 5 wt % to about 70 wt % based on the total composition, preferably, the alkali silicate is present in an amount from about 10 wt % to about 50 wt % based on the total composition and more preferably, the alkali silicate is present in an amount from about 20 wt % to about 40 wt % based on the total composition.

In another embodiment, the filler is present in an amount from 0 wt % to about 90 wt % based on the total composition, preferably, the filler is present in an amount from 20 wt % to about 80 wt % based on the total composition and more preferably, the filler is present in an amount from 50 wt % to about 75 wt % based on the total composition.

In one embodiment, two or more fillers are present.

In some embodiments, the filler has an average particle size from about 0.001 micron to about 5 mm, preferably, the filler has an average particle size from about 0.1 micron to about 100 microns, and more preferably, the filler has an average particle size from about 10 microns to about 75 microns.

In other embodiments, the coating composition is cured at a temperature of about 60° C. to about 100° C.

In one embodiment, the coating composition is cured at a temperature of about 80° C.

In another embodiment, the coating composition cure time ranges from about 5 min to about 10 hours, preferably, the composition cure time ranges from about 30 min to about 7 hours, and more preferably, the composition cure time ranges from about 1 hour to about 5 hours.

In some embodiments, the coating composition has a viscosity of about 5 cP to about 100,000 cP at a temperature of about 25° C., preferably, the composition has a viscosity of about 100 cP to about 10,000 cP at a temperature of about 25° C., and more preferably, the composition has a viscosity of about 500 cP to about 5,000 cP at a temperature of about 25° C.

In further embodiments, the average flexural strength of the coating composition ranges from about 0.5 MPa to about 50 MPa, preferably, the average flexural strength of the composition ranges from about 5 MPa to about 30 MPa, and more preferably, the average flexural strength of the composition ranges from about 10 MPa to about 20 MPa.

In another embodiment, the total thickness of the coating is from about 0.5 gsm to about 100 gsm, preferably, the total thickness of the coating is from about 5 gsm to about 25 gsm, and more preferably, the total thickness of the coating is from about 10 gsm to about 20 gsm.

In some embodiments, the coating is applied with groove rod, paint roller or combinations thereof.

In other embodiments, a method for preparing a fire retardant intumescent coating composition, can include placing a substrate on a coating stage; pouring a geopolymer mix at the top of the substrate; spreading the geopolymer mix evenly with groove rod or paint roller; curing the coated substrate in an oven at 80° C. for about 5 minutes; repeating the coating process on the opposite side of the substrate; curing the coated substrate in an oven at 80° C. for about 15 minutes; and placing the double-coated substrate samples in an individual plastic bags prior to flame testing to form the fire retardant intumescent coating composition.

In some embodiments, a method for preparing a wood composite product, can include contacting a plurality of wood substrates with a fire retardant intumescent coating composition, wherein the coating composition can include an alkali metal geopolymer binder; and at least one filler; and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; and at least one filler.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### III. Fire Retardant Intumescent Coating Composition and Wood Composite Product from Alkali Metal Geopolymer Binder, Filler(s) and Gel

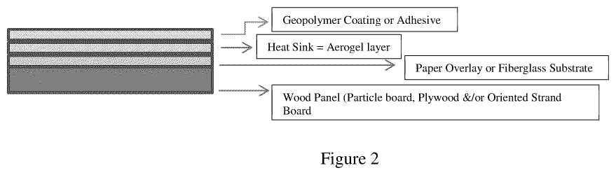

FIG. 2 depicts an illustrative view of a fire retardant intumescent coating composition and wood panel of an alkali metal geopolymer binder, filler, gel and an optional paper overlay. The construct does not limit the position of any particular layer for geopolymer binder, filler, gel and paper overlay. The geopolymer composition or gel or paper overlay can be either in top, middle or bottom layers.

In some embodiments, a fire retardant intumescent coating composition, can include an alkali metal geopolymer binder; at least one filler; and a gel.

In one embodiment, the alkali metal geopolymer binder can include a metakaolin; and an alkali silicate in a solvent.

In another embodiment, the coating composition further can include a paper overlay.

In some embodiments, the gel can include a wet gel, a dry gel, an aerogel, or combinations thereof.

In other embodiments, the aerogel can include a cellulosic aerogel, a carbon aerogel, a silica aerogel, an alumina aerogel, a ceramic oxide aerogel, a clay aerogel, a graphene aerogel, a hybrid aerogel, a metallic aerogel, an organometallic aerogel, an organic aerogel, an inorganic aerogel, an alginate-based aerogel, a polymeric aerogel, or combinations thereof.

In some embodiments, the formation of silica aerogels involves two major steps, the first is the formation of a sol-gel like material, and the second is drying of the sol-gel like material to form the aerogel. In the past, the sol-gel like materials were made by an aqueous condensation of sodium silicate, or a similar material. While this process works relatively well, the reaction forms salts within the gel that needs to be removed by an expensive ion exchange technology, and repetitive washing. With the recent development of sol-gel-chemistry over the last few decades, a vast majority of silica aerogels prepared today utilize silicon alkoxide precursors. Arclin's geopolymer formulations contain sodium silicate and could potentially be used to generate the aerogel as a heat insulating layer that is further coated on the top layer with a geopolymer formulation that acts as the fire retardant layer. Further, these silica aerogels can be further infused with non-halogen based fire retardants that are readily available in the market to add an additional layer of fire retardancy. The geopolymer coating/top layer could further incorporate “zeolites”, that are mainly aluminosilicate porous ceramic crystals to further improve insulation properties.

In one embodiment, the aerogel is infused with a fire retardant.

In further embodiments, the fire retardant is selected from the group consisting of micronized melamine, melamine cyanurates, melamine phosphates, zinc borates, antimony pentoxide, cholorophosphate-based, mineral-based, antimony oxide, halogenated, and combinations thereof.

In other embodiments, a method for preparing a wood composite product, can include contacting a plurality of wood substrates with a fire retardant intumescent coating composition, wherein the coating composition can include an alkali metal geopolymer binder; at least one filler; and a gel; and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; at least one filler; and a gel.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### IV. Fire Retardant Intumescent Coating Composition and Wood Composite Product from Alkali Metal Geopolymer Binder, Filler(s) and Organic Intumescent Coating Component

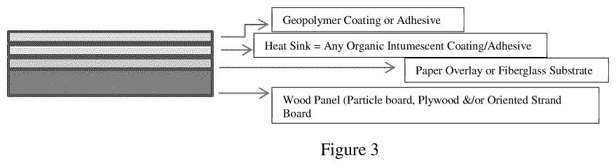

FIG. 3 depicts an illustrative view of a fire retardant intumescent coating composition and wood panel of an alkali metal geopolymer binder, filler, organic intumescent coating component and an optional paper overlay. The construct does not limit the position of any particular layer for geopolymer binder, filler, organic intumescent coating component and paper overlay. The geopolymer composition or organic intumescent coating component or paper overlay can be either in top, middle or bottom layers.

In some embodiments, a fire retardant intumescent coating composition, can include an alkali metal geopolymer binder; at least one filler; and an organic intumescent coating component.

In one embodiment, the alkali metal geopolymer binder can include a metakaolin; and an alkali silicate in a solvent.

In another embodiment, the coating composition further can include a paper overlay.

In some embodiments, the organic intumescent coating component can include styrene acrylic epoxy hybrid, aluminum trihydrate, melamine powder, melamine phosphate, expanded graphite, pentaerythritol, or combinations thereof.

In other embodiments, a method for preparing a wood composite product, can include contacting a plurality of wood substrates with a fire retardant intumescent coating composition, wherein the coating composition can include an alkali metal geopolymer binder; at least one filler; and an organic intumescent coating component; and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; at least one filler; and an organic intumescent coating component.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### V. Fire Retardant Intumescent Coating Composition and Wood Composite Product from Alkali Metal Geopolymer Binder, Filler(s), Gel and Organic Intumescent Coating Component

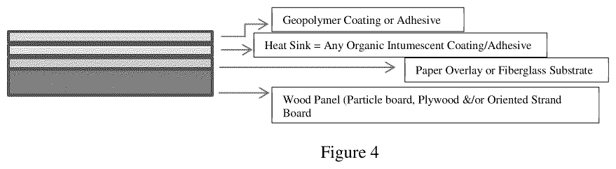

FIG. 4 depicts an illustrative view of a fire retardant intumescent coating composition and wood panel of an alkali metal geopolymer binder, filler, gel, organic intumescent coating component and an optional paper overlay. The construct does not limit the position of any particular layer for geopolymer binder, filler, gel, organic intumescent coating component and paper overlay. The geopolymer composition or gel or organic intumescent coating component or paper overlay can be either in top, middle or bottom layers.

In some embodiments, a fire retardant intumescent coating composition, can include an alkali metal geopolymer binder; at least one filler; a gel; and an organic intumescent coating component.

In one embodiment, the alkali metal geopolymer binder can include a metakaolin; and an alkali silicate in a solvent.

In another embodiment, the coating composition further can include a paper overlay.

In some embodiments, the gel can include a wet gel, a dry gel, an aerogel, or combinations thereof.

In other embodiments, the aerogel can include a cellulosic aerogel, a carbon aerogel, a silica aerogel, an alumina aerogel, a ceramic oxide aerogel, a clay aerogel, a graphene aerogel, a hybrid aerogel, a metallic aerogel, an organometallic aerogel, an organic aerogel, an inorganic aerogel, an alginate-based aerogel, a polymeric aerogel, or combinations thereof.

In some embodiments, the formation of silica aerogels involves two major steps, the first is the formation of a sol-gel like material, and the second is drying of the sol-gel like material to form the aerogel. In the past, the sol-gel like materials were made by an aqueous condensation of sodium silicate, or a similar material. While this process works relatively well, the reaction forms salts within the gel that needs to be removed by an expensive ion exchange technology, and repetitive washing. With the recent development of sol-gel-chemistry over the last few decades, a vast majority of silica aerogels prepared today utilize silicon alkoxide precursors. Arclin's geopolymer formulations contain sodium silicate and could potentially be used to generate the aerogel as a heat insulating layer that is further coated on the top layer with a geopolymer formulation that acts as the fire retardant layer. Further, these silica aerogels can be further infused with non-halogen based fire retardants that are readily available in the market to add an additional layer of fire retardancy. The geopolymer coating/top layer could further incorporate “zeolites”, that are mainly aluminosilicate porous ceramic crystals to further improve insulation properties.

In one embodiment, the aerogel is infused with a fire retardant.

In further embodiments, the fire retardant is selected from the group consisting of micronized melamine, melamine cyanurates, melamine phosphates, zinc borates, antimony pentoxide, cholorophosphate-based, mineral-based, antimony oxide, halogenated, and combinations thereof.

In some embodiments, the organic intumescent coating component can include styrene acrylic epoxy hybrid, aluminum trihydrate, melamine powder, melamine phosphate, expanded graphite, pentaerythritol, or combinations thereof.

In other embodiments, a method for preparing a wood composite product, can include contacting a plurality of wood substrates with a fire retardant intumescent coating composition, wherein the coating composition can include an alkali metal geopolymer binder; at least one filler; a gel; and an organic intumescent coating component; and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; at least one filler; a gel; and an organic intumescent coating component.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### VI. Fire Retardant Intumescent Coating Composition and Wood Composite Product from Alkali Metal Geopolymer Binder, Filler(s), Gel, Organic Intumescent Coating Component and Paper Overlay Saturated with Geopolymer Composition

FIG. 4 also depicts an illustrative view of a fire retardant intumescent coating composition and wood panel of an alkali metal geopolymer binder, filler, gel, organic intumescent coating component and paper overlay saturated with geopolymer composition. The construct does not limit the position of any particular layer for geopolymer binder, filler, gel, organic intumescent coating component and paper overlay saturated with geopolymer composition. The geopolymer composition or gel or organic intumescent coating component or paper overlay saturated with geopolymer composition can be either in top, middle or bottom layers.

In some embodiments, a fire retardant intumescent coating composition, can include an alkali metal geopolymer binder; at least one filler; a gel; an organic intumescent coating component; and a paper overlay saturated with geopolymer composition.

In one embodiment, the alkali metal geopolymer binder can include a metakaolin; and an alkali silicate in a solvent.

In another embodiment, the alkali metal geopolymer composition can include a metakaolin; an alkali silicate in a solvent; and at least one filler.

In some embodiments, the gel can include a wet gel, a dry gel, an aerogel, or combinations thereof.

In other embodiments, the aerogel can include a cellulosic aerogel, a carbon aerogel, a silica aerogel, an alumina aerogel, a ceramic oxide aerogel, a clay aerogel, a graphene aerogel, a hybrid aerogel, a metallic aerogel, an organometallic aerogel, an organic aerogel, an inorganic aerogel, an alginate-based aerogel, a polymeric aerogel, or combinations thereof.

In some embodiments, the formation of silica aerogels involves two major steps, the first is the formation of a sol-gel like material, and the second is drying of the sol-gel like material to form the aerogel. In the past, the sol-gel like materials were made by an aqueous condensation of sodium silicate, or a similar material. While this process works relatively well, the reaction forms salts within the gel that needs to be removed by an expensive ion exchange technology, and repetitive washing. With the recent development of sol-gel-chemistry over the last few decades, a vast majority of silica aerogels prepared today utilize silicon alkoxide precursors. Arclin's geopolymer formulations contain sodium silicate and could potentially be used to generate the aerogel as a heat insulating layer that is further coated on the top layer with a geopolymer formulation that acts as the fire retardant layer. Further, these silica aerogels can be further infused with non-halogen based fire retardants that are readily available in the market to add an additional layer of fire retardancy. The geopolymer coating/top layer could further incorporate “zeolites”, that are mainly aluminosilicate porous ceramic crystals to further improve insulation properties.

In one embodiment, the aerogel is infused with a fire retardant.

In further embodiments, the fire retardant is selected from the group consisting of micronized melamine, melamine cyanurates, melamine phosphates, zinc borates, antimony pentoxide, cholorophosphate-based, mineral-based, antimony oxide, halogenated, and combinations thereof.

In some embodiments, the organic intumescent coating component can include styrene acrylic epoxy hybrid, aluminum trihydrate, melamine powder, melamine phosphate, expanded graphite, pentaerythritol, or combinations thereof.

In other embodiments, a method for preparing a wood composite product, can include contacting a plurality of wood substrates with a fire retardant intumescent coating composition, wherein the coating composition can include an alkali metal geopolymer binder; at least one filler; a gel; an organic intumescent coating component; and a paper overlay saturated with geopolymer composition; and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; at least one filler; a gel; an organic intumescent coating component; and a paper overlay saturated with geopolymer composition.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

In further embodiment, a paper overlaid wood board, can include an oriented strand board core having a bottom surface and a top surface, wherein the oriented strand board comprises a plurality of strands; and at least cured fire retardant intumescent coating composition, wherein the coating composition can include an alkali metal geopolymer binder; at least one filler; a gel; an organic intumescent coating component; a paper overlay saturated with geopolymer composition; and a coating composition adhesively secured to the top surface of the oriented strand board.

In one embodiment, the paper overlay can include a kraft paper.

### VII. Fire Retardant Intumescent Coating Composition and Wood Composite Product from Alkali Metal Geopolymer Binder, Filler(s), Gel, Organic Intumescent Coating Component and Aldehyde-Based Resin

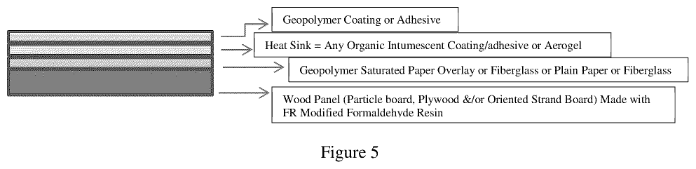

FIG. 5 depicts an illustrative view of a fire retardant intumescent coating composition and wood panel of an alkali metal geopolymer binder, filler, gel, organic intumescent coating component, aldehyde-based resin and an optional paper overlay. The construct does not limit the position of any particular layer for geopolymer binder, filler, gel, organic intumescent coating component, aldehyde-based resin and paper overlay. The geopolymer composition or gel or organic intumescent coating component or aldehyde-based resin or paper overlay can be either in top, middle or bottom layers.

In some embodiments, a fire retardant intumescent coating composition, can include an alkali metal geopolymer binder; at least one filler; a gel; an organic intumescent coating component; and an aldehyde-based resin.

In one embodiment, the alkali metal geopolymer binder can include a metakaolin; and an alkali silicate in a solvent.

In another embodiment, the coating composition further can include a paper overlay.

In some embodiments, the gel can include a wet gel, a dry gel, an aerogel, or combinations thereof.

In other embodiments, the aerogel can include a cellulosic aerogel, a carbon aerogel, a silica aerogel, an alumina aerogel, a ceramic oxide aerogel, a clay aerogel, a graphene aerogel, a hybrid aerogel, a metallic aerogel, an organometallic aerogel, an organic aerogel, an inorganic aerogel, an alginate-based aerogel, a polymeric aerogel, or combinations thereof.

In some embodiments, the formation of silica aerogels involves two major steps, the first is the formation of a sol-gel like material, and the second is drying of the sol-gel like material to form the aerogel. In the past, the sol-gel like materials were made by an aqueous condensation of sodium silicate, or a similar material. While this process works relatively well, the reaction forms salts within the gel that needs to be removed by an expensive ion exchange technology, and repetitive washing. With the recent development of sol-gel-chemistry over the last few decades, a vast majority of silica aerogels prepared today utilize silicon alkoxide precursors. Arclin's geopolymer formulations contain sodium silicate and could potentially be used to generate the aerogel as a heat insulating layer that is further coated on the top layer with a geopolymer formulation that acts as the fire retardant layer. Further, these silica aerogels can be further infused with non-halogen based fire retardants that are readily available in the market to add an additional layer of fire retardancy. The geopolymer coating/top layer could further incorporate “zeolites”, that are mainly aluminosilicate porous ceramic crystals to further improve insulation properties.

In one embodiment, the aerogel is infused with a fire retardant.

In further embodiments, the fire retardant is selected from the group consisting of micronized melamine, melamine cyanurates, melamine phosphates, zinc borates, antimony pentoxide, cholorophosphate-based, mineral-based, antimony oxide, halogenated, and combinations thereof.

In some embodiments, the organic intumescent coating component can include styrene acrylic epoxy hybrid, aluminum trihydrate, melamine powder, melamine phosphate, expanded graphite, pentaerythritol, or combinations thereof.

In other embodiments, the aldehyde-based resin can include a phenol-formaldehyde resin, a urea-formaldehyde resin, a melamine-formaldehyde resin, a melamine-urea-formaldehyde resin, a phenol-melamine-formaldehyde resin, a resorcinol-formaldehyde resin, a phenol-resorcinol-formaldehyde resin, or combinations thereof.

In one embodiment, the aldehyde-based resin is fire retardant modified formaldehyde-based resin.

In another embodiment, the aldehyde-based resin is emulsified fire retardant formaldehyde-based resin.

In other embodiments, a method for preparing a wood composite product, can include contacting a plurality of wood substrates with a fire retardant intumescent coating composition, wherein the coating composition can include an alkali metal geopolymer binder; at least one filler; a gel; an organic intumescent coating component; and an aldehyde-based resin and curing the coating composition to produce the wood composite product.

In some embodiments, the coating composition is cured at a temperature of about 60° C. to about 100° C.

In one embodiment, the coating composition is cured at a temperature of 80° C.

In another embodiment, a wood composite product, can include a plurality of wood substrates and at least cured fire retardant intumescent coating composition, wherein the coating composition can include an alkali metal geopolymer binder; at least one filler; a gel; an organic intumescent coating component; and an aldehyde-based resin.

In some embodiments, the plurality of wood substrates can include lignocellulose substrates.

In other embodiments, the wood composite product can include plywood, oriented strand board, oriented strand lumber, laminated veneer lumber, laminated veneer timber, laminated veneer boards, particleboard, fiberboard, chipboard, flakeboard, high density fiberboard, medium density fiberboard, waferboard, hardwood, softwood plywood, veneer timber, parallel standard lumber, oriented stranded lumber, or combinations thereof.

### VIII. Industrial Applications

The present invention is about specialty product(s) that are based on “hybrid technology,” which is a combination of various tailor made “geopolymers” with existing adhesives, overlays, coatings, and paint technologies along with various substrates. A fire retardant intumescent coating composition and wood composite products prepared from geopolymer compositions of the present invention offer several industrial applications including, but not limited to, fire retardant wood-based composite construct and panels, fiberglass mat for roofing shingles, fiber reinforced geopolymers (a replacement for traditional formaldehyde or petro chemical based fiber reinforced plastics), glass reinforced facer mat, slit ribbons for tube and core manufacturing, rigid & thermal roofing underlayment, molded and/or extruded products such as refractory bricks and custom molded composites for aerospace and automotive applications, saturation and/or coating of paper and other carriers for use as an overlay in the lamination process, use as caulks, paints, and adhesives, 3D printed products (including specialty parts and 3D printed home applications), and oil-field application in the form of water, gas, oil, and sand control and/or as an acidizing diverter.

Further, the present invention displays major benefits and vital utility in major industrial fields, which include, but not limited to, 1) Fire retardant (FR) capabilities will be greatly increased based on inorganic structure of geopolymer component. 2) Achieved optimal surface sealing that in turn results in reduced/no flame spread on the surface and increased resistance to scratching. 3) Most FR additives reduce end product mechanical strength when used in combination with an adhesive technology. Geopolymer binder plus filler of choice offers to achieve equivalent or better internal bond strength and modulus of rupture while exhibiting faster cure speeds and degree of cure with lower formaldehyde emissions. 4) The new geopolymer binder plus lignosulfonate and/or polyol stabilizer binder systems can be used as the novel no emissions/no-added formaldehyde resin system that performs better than incumbent technology. The geopolymer-based material can potentially be a good moisture barrier. 6) Geopolymer compositions offer high level of chemical resistance which can be used for industrial/chemical storage tank coatings and offer increased FR benefits to sequestered volatile waste.

Additionally, the combination of unique geopolymer formulation (that includes filler(s) of choice) by itself and in combination with an adhesive(s) (both thermoset and thermoplastic), coating(s) (both thermoplastic and thermoset) and paint(s) (both thermoplastic and thermoset) along with a substrate (such as fiberglass, carbon fiber, cellulose, wood etc) that exhibited unique and drastically improved finished product properties with no emissions or zero emissions with significantly improved FR characteristics.

### EXAMPLES

To provide a better understanding of the foregoing discussion, the following non-limiting examples are provided. Although the examples may be directed to specific embodiments, they are not to be viewed as limiting the invention in any specific respect.

### Example 1: Preparation of Potassium Geopolymer Composition with Fumed Silica (SiO₂) Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Fumed silica (7.5 wt %, 5.0 wt % and 10.5 wt %) added to binder slurry, ranging from 1-10 wt %, while stirring was stopped during the addition. The mixture was stirred on setting 1 (lowest speed) and gradually increased to setting 9 (medium-high speed) to ensure homogenization of reactants and eliminate clumps of filler. Resultant slurry was stirred for a total of 15 minutes. The slurry was then poured in a plastic bottle.

Table 1 shows potassium geopolymer composition containing 7.5 wt. % of fumed silica.

TABLE 1
Coating Formulation #1

| | Reagent | | Composition | | Amount | Amount |
|---|---|---|---|---|---|---|
| Reagent | Name | Supplier | notes | Wt % | needed (g) | added (g) |
| Potassium | KASIL 6 | PQ Corp | 65.7% water, | 64.6 | 300 | 300.0 |
| silicate solution | | | Si₂O:K₂O = 1.7 | | | |
| Metakaolin | MetaMax | BASF | 45.9% Al₂O₃ | 27.9 | 129.4 | 129.4 |
| (calcined kaolin) | | | | | | |
| Fumed silica | S5130 | Sigma | Particle | 7.5 | 34.8 | 34.9 |
| | | | size = 7 nm | | | |

Table 2 shows potassium geopolymer composition containing 5.0 wt. % of fumed silica.

TABLE 2
Coating composition #2

| | Reagent | | Composition | | Amount | Amount |
|---|---|---|---|---|---|---|
| Reagent | Name | Supplier | notes | Wt % | needed (g) | added (g) |
| Potassium | KASIL 6 | PQ Corp | 65.7% water, | 66.4 | 300 | 300.0 |
| silicate solution | | | Si₂O:K₂O = 1.7 | | | |
| Metakaolin | MetaMax | BASF | 45.9% Al₂O₃ | 28.6 | 129.4 | 129.4 |
| (calcined clay) | | | | | | |
| Fumed silica | S5130 | Sigma | Particle | 5.0 | 22.6 | 22.6 |
| | | | size = 7 nm | | | |

Table 3 shows potassium geopolymer composition containing 10.5 wt. % of fumed silica.

TABLE 3
Coating composition #3

| | Reagent | | Composition | | Amount | Amount |
|---|---|---|---|---|---|---|
| Reagent | Name | Supplier | notes | Wt % | needed (g) | added (g) |
| Potassium | KASIL 6 | PQ Corp | 65.7% water, | 62.5 | 300 | 300.1 |
| silicate solution | | | Si₂O:K₂O = 1.7 | | | |
| Metakaolin | MetaMax | BASF | 45.9% Al₂O₃ | 27.0 | 129.4 | 129.4 |
| (calcined kaolin) | | | | | | |
| Fumed silica | Fumed | Sigma | Particle | 10.5 | 50.2 | 50.5 |
| | silica | | size = 7 nm | | | |

### Example 2: Preparation of Potassium Geopolymer Composition with Feldspar Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Feldspar filler (42.4 wt % and 29.8 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 4 shows potassium geopolymer composition containing 42.4 wt. % of feldspar filler.

TABLE 4
Coating formulation #4

| | | | | | Amount |
|---|---|---|---|---|---|
| | Reagent | | Composition | Wt | needed |
| Reagent | Name | Supplier | notes | % | (g) |
| Potassium | KASIL 6 | PQ | 65.7% water, | 38.4 | 150 |
| silicate | | Corp | Si₂O:K₂O = 1.7 | | |
| solution | | | | | |
| Metakaolin | MetaMax | BASF | 45.9% Al₂O₃ | 19.2 | 74.8 |
| (calcined | | | | | |
| kaolin) | | | | | |
| Feldspar | Minspar250 | Imerys | Particle | 42.4 | 165.7 |
| | | | size = 10.6 μm | | |

Table 5 shows potassium geopolymer composition containing 29.8 wt. % of feldspar filler.

TABLE 5
Coating formulation #5

| | | | | | Amount |
|---|---|---|---|---|---|
| | Reagent | | Composition | Wt | needed |
| Reagent | Name | Supplier | notes | % | (g) |
| Potassium | KASIL 6 | PQ | 65.7% water, | 48.9 | 200 |
| silicate | | Corp | Si₂O:K₂O = 1.7 | | |
| solution | | | | | |
| Metakaolin | MetaMax | BASF | 45.9% Al₂O₃ | 21.2 | 86.5 |
| (calcined | | | | | |
| kaolin) | | | | | |
| Feldspar | Minspar250 | Imerys | Particle | 29.8 | 122.1 |
| | | | size = 10.6 μm | | |

### Example 3: Preparation of Potassium Geopolymer Composition with Perlite Filler

Metakaolin was measured into stainless steel planetary mixing bowl. Potassium silicate solution was measured into disposable plastic cup. Potassium silicate solution was poured into mixing bowl and briefly stirred with rubber spatula to wet ingredients. The mixture was stirred with whisk attachment for 15 minutes on medium speed to start geopolymer reaction. Perlite filler (47.9 wt %) was added to the mixture. The mixture was stirred for 5-10 minutes or until homogeneous. Mixture was then poured into pre-greased silicone molds on a vibrating table to eliminate air bubbles. Two sets of 4 samples were prepared to cure at different time points. Molds were covered with plastic sheeting to prevent water loss and placed in oven at 80° C. Samples taken from the oven at 3.5, 4, and 4.5 hours to evaluate time vs. cure behavior. After removing from the oven, samples were allowed to cool for 30 minutes before de-molding. Samples were evaluated with 3-point bend test.

Table 6 shows potassium geopolymer composition containing 47.9 wt. % of perlite filler.

TABLE 6
Coating formulation #6

| | | | | | Amount |
|---|---|---|---|---|---|
| | Reagent | | Composition | Wt | needed |
| Reagent | Name | Supplier | notes | % | (g) |
| Potassium | KASIL 6 | PQ | 65.7% water, | 34.7 | 150 |
| silicate solution | | Corp | Si₂O:K₂O = 1.7 | | |
| Metakaolin | MetaMax | BASF | 45.9% Al₂O₃ | 17.4 | 74.9 |
| (calcined | | | | | |
| kaolin) | | | | | |
| Perlite | PA1000 | Imerys | — | 47.9 | 206.6 |

### Example 4: General Procedure for Fire Retardant Intumescent Coating with Groove Rod

Substrate (fiberglass sheet, composite board, paper) was placed on coating stage. Thick line of geopolymer mix (KGEOFS7.5, KGEOFS10.5) was poured at top of sheet. HS60 groove rod was used to evenly coat the fiberglass sheet with the geopolymer mix. For initial coating trials, the groove rod was used in several directions. For later trials, the groove rod technique was improved and only one direction of coating was required. For KGEOFS10.5 coating trials, the geopolymer mix became thick and glue-like as the coating trials progressed, making the process more difficult and less accurate. The geopolymer tended to not spread as easily. The coated fiberglass sheets were cured in an 80° C. oven for 5 minutes to eliminate tack. Then, the coating process was repeated on the opposite side in order to completely seal the fiberglass substrate. The samples were then cured in the same oven temperature for an additional 15 minutes. Double-coated samples were placed in individual plastic bags for >2 days before undergoing flame testing.

### Example 5: General Procedure for Fire Retardant Intumescent Coating with Paint Roller

Fiberglass sheets were placed on coating stage. Thick line of geopolymer mix (KGEOFS7.5, KGEOFS10.5) was poured at top of sheet. Paint Roller with 2 different Roller Heads were used to evenly coat the fiberglass sheet with the geopolymer mix. Application techniques were slightly altered: 1) apply “line” of GEO above sheet and spread down vs. 2) apply “zigzag” pattern of GEO on sheet and spread. Valspar Trim Roller (thick diameter) vs. Whizz Velour Roller (thin diameter). Final 2-sided coating weights were similar for each roller head. For KGEOFS10.5 coating trials, the geopolymer mix became thick and glue-like as the coating trials progressed, making the process more difficult and less accurate. The geopolymer tended to not spread as easily. The coated fiberglass sheets were cured in an 80° C. oven for 5 minutes to eliminate tack. Then, the coating process was repeated on the opposite side in order to completely seal the fiberglass substrate. The samples were then cured in the same oven temperature for an additional 15 minutes. Double-coated samples were placed in individual plastic bags for >2 days before undergoing flame testing

### Example 6: General Procedure for Making Wood Composite Product

Potassium geopolymer binder composition with 2-10 wt. % fumed Silica (SiO₂) was coated on wood substrate using either a grooved roller or a paint roller. For single-sided coats, the coated wood substrate was cured in an 80° C. oven for 15 minutes. For double-sided coats, the wood substrate was first cured for 5 minutes at 80° C. to eliminate tack, and then cured for 15 minutes after coating application on the opposite side. For double coats on a single side of the wood substrate, the substrate was let to stand at ambient temperature for 10-15 minutes after the first coat to eliminate tack. After application of the second coat, the wood substrate was then cured for 15 minutes at 80° C.

### Example 7: RF or PRF Gel Batch Process

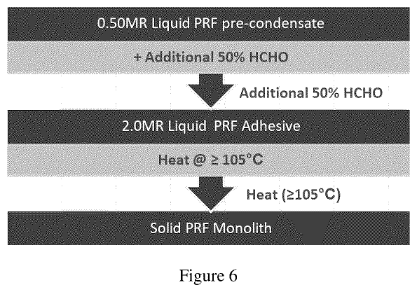

A liquid resorcinol-formaldehyde (RF) or phenol-resorcinol-formaldehyde (PRF) polymer or pre-condensate was prepared by polymerizing phenol and/or resorcinol with formaldehyde in presence of organic acids (e.g., formic acid, toluene-sulfonic acid, methanesulfonic acid, citric acid, acetic acid, sulfamic acid, etc.) using a molar ratio (MR) of 0.25-0.90 moles of formaldehyde to moles of [phenol +resorcinol] and condensation temperatures of 60-150° C. The liquid pre-condensate was further blended with additional formaldehyde either in the original reaction vessel, a secondary vessel, or via continuous or in-line feeding and mixing such as thru a static mixer to form a “Mixed Adhesive”. Additional formaldehyde added to pre-condensate was preferably in liquid form (formalin) at 20-60% concentration in water and/or methanol solvent. The Wt. % of additional formaldehyde was calculated such that the final molar ratio (MR) of the pre-condensate is greater than 1.0 moles formaldehyde to moles [phenol+resorcinol], preferably 2.0-3.0 molar ratio. The Mixed Adhesive was poured into containers suitable for high-temperature exposure such as high-density plastic or metal drums, crucibles, trays, etc. and then cured and dried in a convection oven at >105° C. oven temperature, preferably 150-300° C. for 10-40 hours, preferably 16-30 hours. The resulting gel or monolith was a cross-linked RF or PRF billet or mold that can be further converted to carbonaceous solids via pyrolysis for use in lithium-ion batteries, ultra-capacitors, high-efficiency lead-acid batteries and similar applications. % Non-Volatiles of dried gel are 60-99%, preferably 70-95% as measured at 125° C. for 6 hours. The above process was referred to as a “Batch Process.” Optional methods for converting the Mixed Adhesive to final gel state is by processing thru either a Batch or “Continuous” or “Semi-Continuous” process using any combination of the following equipment: single or twin-barrel heated extruder, a plug-flow reactor, heat exchanger, spray dryer, microwave or radio-frequency generator. RF or PRF gel batch process is shown in FIG. 6.

### Example 8: Preparation of Potassium Geopolymer Composition with an Organic Intumescent Coating Component

Potassium geopolymer composition from Example 1 to Example 3, Raykote 2020 (styrene acrylic epoxy hybrid) (47.62 wt %), aluminum trihydrate (ATH) (19.05 wt %), melamine powder (19.05 wt %), melamine phosphate (9.52 wt %), expanded graphite or pentaerythritol (4.76 wt %) were blended together using a shear mixer at room temperature (25° C.-30° C.) and made into a stable homogenous, uniform liquid coating that can be applied to wood substrate.

### Example 9: Lamination Process

The manufacture of composite lumber products from veneers involve the application of an adhesive resin to the surfaces of one or more wood veneers, followed by stacking and pressing of the veneers to produce an adhesive bonded laminate. The pressing is generally accompanied by heating of the treated veneers in order to accelerate curing of the adhesive, although cold pressing has also been used. Adhesive bonded laminated wood products include, but not limited to, plywood, laminated veneer lumber (LVL), and parallel strand lumber. Adhesives for manufacturing laminated wood products are predominantly thermosetting adhesives. These include phenol formaldehyde (resole) resins, commonly referred to as PF resins; urea formaldehyde resins (UF resins); melamine formaldehyde resins (MF resins); resorcinol formaldehyde resins (RF resins); polyisocyanate adhesives; and combinations thereof. Phenol formaldehyde (PF) based adhesives are widely used, especially for the manufacture of commodity laminated wood products, such as plywood. PF, UF, RF, MF, and related resins types liberate water during the curing process, which limits the moisture content of the veneers that may be used with these kinds of adhesives. The moisture content of the veneers must typically be below 10% by weight of the veneer (defined as wood plus water), and usually less than 7% by weight. Unfortunately, raw veneers often have a much higher moisture content and must be dried in order to reduce the moisture content to acceptable levels, which is energy intensive and costly. Additionally, PF, UF, MF, and RF type resins require heat in order to cure, which places severe limitations on the thickness (i.e. the number of veneers that may be stacked) of the laminates that can be economically produced. The introduction of heat is typically from an external source, such as a heated press. Thicker laminates require more time for heat transfer, and, therefore, as laminate thickness increases, residence time in the press increases.

### Example 10: General Procedure for Fire Retardant Intumescent Coating with an Aldehyde based Resin

Formaldehyde:Phenol (1.0:3.0) (moles) were suspended in water and/or solvent (alcohol such as methanol, ethanol, isopropanol). Polymerization was catalyzed under alkaline conditions using strong bases such as metal hydroxides (sodium hydroxide, potassium hydroxide, lithium hydroxide), metal oxides (magnesium oxide or calcium oxide) or a liquid amine or amine-salt catalyst (hexamine, trimethylamine, dimethylethanol amine or similar alkyl amine). A proprietary fire retardant solution is added to the PF polymer either during resin manufacture or to the finished resin prior to application to substrate.

While in the foregoing specification this invention has been described in relation to certain embodiments thereof, and many details have been put forth for the purpose of illustration, it will be apparent to those skilled in the art that the invention includes additional embodiments and that certain of the details described herein can be varied considerably without departing from the basic principles of the invention. Although we have described the preferred embodiments for implementing our invention, it will be understood by those skilled in the art to which this disclosure is directed that modifications and additions may be made to our invention without departing from its scope.

All references cited herein are incorporated by reference in their entirety. The present invention may be embodied in other specific forms without departing from the spirit or essential attributes thereof and, accordingly, reference should be made to the appended claims, rather than to the foregoing specification, as indicating the scope of the invention.

We claim:

1. A fire retardant intumescent coating composition, comprising:
an alkali metal geopolymer binder; and
at least one filler.

2. The coating composition of claim 1, wherein the alkali metal geopolymer binder comprises a metakaolin; and an alkali silicate in a solvent.

3. The coating composition of claim 1, further comprising a paper overlay.

4. The coating composition of claim 1, wherein the composition is cured at a temperature of about 60° C. to about 100° C.

5. The coating composition of claim 1, wherein the average flexural strength of the composition ranges from about 0.5 MPa to about 50 MPa.

6. The coating composition of claim 1, wherein the total thickness of the coating is from about gsm to about 100 gsm.

7. The coating composition of claim 1, wherein the coating is applied with groove rod, paint roller or combinations thereof.

8. A fire retardant intumescent coating composition, comprising:
an alkali metal geopolymer binder;
at least one filler; and
a gel.

9. The coating composition of claim 8, wherein the gel comprises a wet gel, a dry gel, an aerogel, or combinations thereof.

10. The coating composition of claim 9, wherein the aerogel comprises a cellulosic aerogel, a carbon aerogel, a silica aerogel, an alumina aerogel, a ceramic oxide aerogel, a clay aerogel, a graphene aerogel, a hybrid aerogel, a metallic aerogel, an organometallic aerogel, an organic aerogel, an inorganic aerogel, an alginate-based aerogel, a polymeric aerogel, or combinations thereof.

11. The coating composition of claim 9, wherein the aerogel is infused with a fire retardant.

12. The coating composition of claim 11, wherein the fire retardant is selected from the group consisting of micronized melamine, melamine cyanurates, melamine phosphates, zinc borates, antimony pentoxide, cholorophosphate-based, mineral-based, antimony oxide, halogenated, and combinations thereof.

13. A fire retardant intumescent coating composition, comprising:
an alkali metal geopolymer binder;
at least one filler; and
an organic intumescent coating component.

14. The coating composition of claim 13, wherein the organic intumescent coating component comprises styrene acrylic epoxy hybrid, aluminum trihydrate, melamine powder, melamine phosphate, expanded graphite, pentaerythritol, or combinations thereof.

15. A fire retardant intumescent coating composition, comprising:
an alkali metal geopolymer binder;
at least one filler;
a gel; and
an organic intumescent coating component.

16. A fire retardant intumescent coating composition, comprising:
an alkali metal geopolymer binder;
at least one filler;
a gel;
an organic intumescent coating component; and
a paper overlay saturated with geopolymer composition.

17. A fire retardant intumescent coating composition, comprising:
an alkali metal geopolymer binder;
at least one filler;
a gel;
an organic intumescent coating component; and
an aldehyde-based resin.

18. The coating composition of claim 17, wherein the aldehyde-based resin comprises a phenol-formaldehyde resin, a urea-formaldehyde resin, a melamine-formaldehyde resin, a melamine-urea-formaldehyde resin, a phenol-melamine-formaldehyde resin, a resorcinol-formaldehyde resin, a phenol-resorcinol-formaldehyde resin, or combinations thereof.

19. The coating composition of claim 17, wherein the aldehyde-based resin is fire retardant modified formaldehyde-based resin.

20. The coating composition of claim 17, wherein the aldehyde-based resin is emulsified fire retardant formaldehyde-based resin.
